(19) United States
(12) Patent Application Publication
(10) Pub. No.: US 2021/0323301 A1
(43) Pub. Date: Oct. 21, 2021

(54) TEMPERATURE SENSING

(71) Applicant: Hewlett-Packard Development Company, L.P., Spring, TX (US)

(72) Inventors: Rogelio Cicili, San Diego, CA (US); James Michael Gardner, Corvallis, OR (US); Eric Thomas Martin, Corvallis, OR (US); Daryl E. Anderson, Corvallis, OR (US)

(73) Assignee: Hewlett-Packard Development Company, L.P., Spring, TX (US)

(21) Appl. No.: 17/251,241

(22) PCT Filed: Nov. 16, 2018
(86) PCT No.: PCT/US2018/061541

§ 371 Date: Dec. 11, 2020

(51) Int. Cl. B41J 2/045; G01K 7/16; G01K 1/024; B41J 2/05

(52) U.S. Cl. CPC B41J 2/0454; B41J 2/05; G01K 1/024; G01K 7/16

(57) ABSTRACT

Examples of a fluidic die for temperature sensing are described herein. In some examples, the fluidic die includes a plurality of resistor segments connected in series. In some examples, the fluidic die may include a plurality of first switches connected to a first side of each of the plurality of resistor segments. In some examples, the fluidic die includes a plurality of second switches connected to a second side of each of the plurality of resistor segments. In some examples, the fluidic die includes a differential amplifier to output a temperature voltage signal, where a first input of the differential amplifier is each of the first switches, and where a second input of the differential amplifier is connected each of the plurality of second switches.

### BACKGROUND

Fluid ejection systems may be used to emit a fluid. For example, printing devices provide a user with a physical representation of a document by printing a digital representation of a document onto a print medium. The printing devices may include a number of fluidic dies used to eject ink or other printable material onto the print medium to form an image. In some examples, a fluidic die may deposit fluid droplets onto the print medium using a number of fluidic actuators (e.g., resistive elements) within the fluidic die. In other examples, a fluidic actuator may move a fluid on the fluidic die.

### BRIEF DESCRIPTION OF THE DRAWINGS

FIG. 1 A is a block diagram of an example of a fluidic die;

FIG. 1B is a simplified block diagram of an example of a fluid ejection system incorporating a fluidic die;

FIG. 2 is a circuit diagram illustrating an example of fluidic die circuitry;

FIG. 3 is a flow diagram illustrating an example of a method for temperature sensing;

FIG. 4 is a diagram illustrating an example of fluidic die circuitry; and

FIG. 5 is a diagram illustrating an example of fluidic die circuitry.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

The disclosure describes examples of systems, methods and apparatus to implement a resistor (e.g., thermal sense resistor (TSR)) -based thermal sensing on a fluidic die (e.g., print head). A fluidic die is a structure for dispensing fluid. In some examples, a resistor is routed through a region of the fluidic die to be sensed, where points of the resistor may be selectively coupled to a differential amplifier to generate a voltage representative of a local temperature.

In the following description, for purposes of explanation, numerous specific details are set forth in order to provide a thorough understanding of the present systems and methods. As may be appreciated, the present apparatus, systems, and methods may be practiced without these specific details. Reference in the specification to “an example” or similar language means that a particular feature, structure, or characteristic described in connection with that example is included as described, but may not be included in other examples.

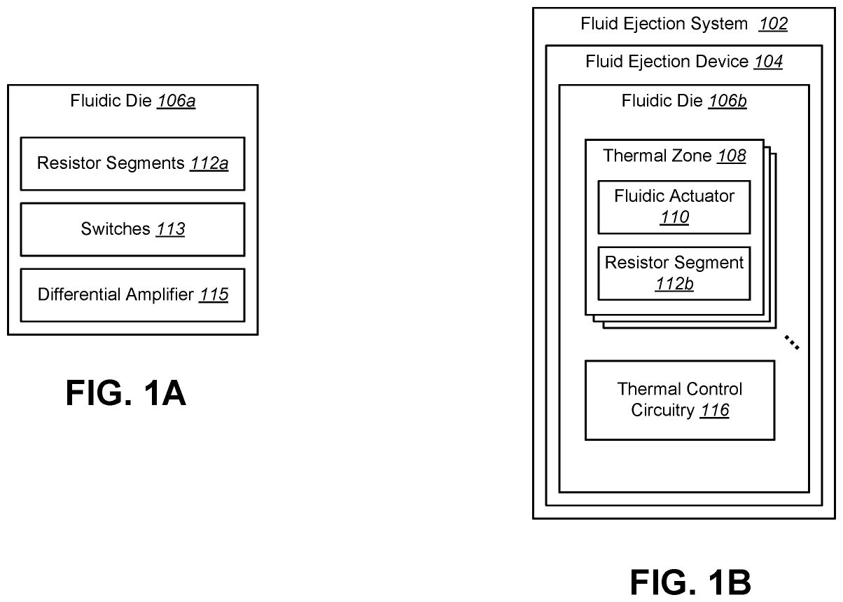

FIG. 1A is a block diagram of an example of a fluidic die 106a. The fluidic die 106a may include a plurality of resistor segments 112a. In some examples, the resistor segments 112a are connected in series. Each of the resistor segments 112a is a portion of a resistor.

In some examples, the fluidic die 106a includes a plurality of switches 113. The switches 113 may be utilized to connect one or more of the resistor segments 112a to a differential amplifier 115. For example, the switches 113 may include a plurality of first switches, where a first terminal of each of the first switches is connected to a first side of each of the plurality of resistor segments 112a. The switches 113 may also include a plurality of second switches, where a first terminal of each of the second switches is connected to a second side of each of the plurality of resistor segments 112a.

The fluidic die 106a may include a differential amplifier 115. The differential amplifier 115 may output a temperature voltage signal. For example, a first input of the differential amplifier 115 may be connected to a second terminal of each of the first switches, and a second input of the differential amplifier 115 may be connected to a second terminal of each of the plurality of second switches. As described in greater detail herein, the differential amplifier 115 may output a temperature voltage signal corresponding to one or more resistor segments 112a.

FIG. 1B is a simplified block diagram of an example of a fluid ejection system 102 incorporating a fluidic die 106b. The fluid ejection system 102 may include various hardware components. For example, among these hardware components may be a number of processors, a number of data storage devices, a number of peripheral device adapters, and a number of network adapters (not shown). These hardware components may be interconnected through the use of a number of busses and/or network connections.

In some examples, the fluid ejection system 102 may be a two-dimensional (2D) printer (e.g., thermal inkjet printer, piezoelectric inkjet printer, etc.) In other examples, the fluid ejection system 102 may be a three-dimensional (3D) printer. In other examples, the fluid ejection system 102 may correspond to pharmaceutical dispensation devices, lab-on-a-chip devices, fluidic diagnostic circuits, and/or other such devices in which small volumes (e.g., microliters, picoliters, etc.) of fluid may be conveyed, analyzed, and/or dispensed.

The fluid ejection system 102 also includes a number of fluid ejection devices 104. Although one fluid ejection device 104 is depicted in the example of FIG. 1B, any number of fluid ejection devices 104 may exist within the fluid ejection system 102. The fluid ejection devices 104 may be fixed or scanning fluid ejection devices. The fluid ejection devices 104 may be coupled to the processor of the fluid ejection system 102 via a bus. The fluid ejection devices 104 may receive print data in the form of a print job. For example, the print data may be used by the fluid ejection devices 104 to produce a physical print representing the print job.

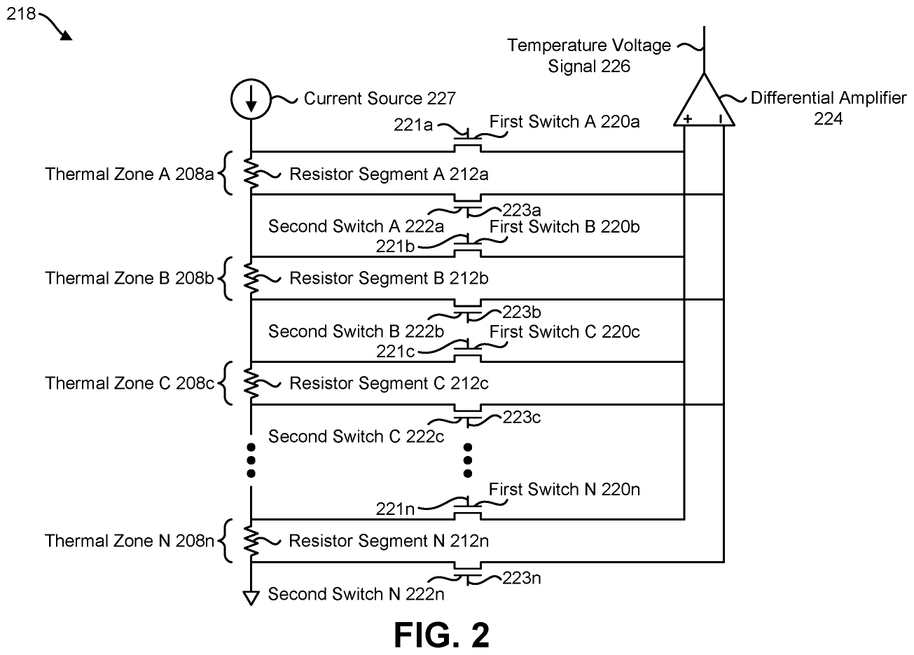

Each fluid ejection device 104 includes a number of fluidic dies 106b. Although one fluidic die 106b is depicted in the example of FIG. 1B, any number of fluidic dies 106b may exist within the fluid ejection device 104. A fluidic die 106b may include multiple thermal zones 108. An example of fluidic die circuitry is described in connection with FIG. 2. In some implementations, the fluidic die 106b described in connection with FIG. 1B may be an example of the fluidic die 106a described in connection with FIG. 1A.

A thermal zone is an area of the fluidic die 106b in which temperature is to be sensed and/or measured. In some examples, each thermal zone 108 may include a number of fluidic actuators 110. A fluidic actuator 110 is a device to move (e.g., eject, expel) fluid from a fluid chamber of the fluidic die 106b. A fluid chamber is a container or volume that holds fluid. In some examples, the thermal zones 108 may include a single fluidic actuator 110 or multiple fluidic actuators 110. A primitive is a structure for printing that may include circuitry and a nozzle or nozzles for expelling fluid. In some implementations, a number of fluidic actuators 110 may be grouped into a primitive or primitives. It should be noted that there may be any number of fluidic actuators 110, nozzles, primitives, or parts of primitives in a thermal zone 108. In some examples, a thermal zone 108 may not include a fluidic actuator 110 or primitive and/or may be independent of a fluidic actuator 110 or primitive. In some implementations, there may be an integer number of primitives in a thermal zone 108 (e.g., 8).

In some examples, the fluidic actuator 110 may be an ejecting actuator. An ejecting actuator may correspond to a fluidic actuator 110 disposed in an ejection chamber, where the ejection chamber may be fluidically coupled to a nozzle. Accordingly, by electrically actuating an ejection actuator, a drop of fluid may be ejected via the nozzle fluidically coupled to the ejection chamber. For instance, a fluid (e.g., ink) may flow through the fluidic die 106b to a fluidic actuator 110. In some examples, the fluidic actuator 110 may deposit the fluid on a print medium. In other examples, the fluidic actuator 110 may eject the fluid without a print medium. Examples of the fluidic die 106b that eject fluid are fluid ejection dies. In some examples, the fluidic die 106b and/or a fluid ejection die may be or may be included in a print head.

In some examples, the fluidic actuator 110 may use heat to cause the fluid to exit the fluidic actuator 110 (through a nozzle, for instance). For instance, the fluidic actuator 110 may generally refer to a resistor (e.g., thermal resistor or a piezoelectric resistor) disposed in an ejection chamber.

In other examples, the fluidic actuator 110 may be a non-ejecting actuator. For example, the fluidic actuator 110 may be a micro-pump that moves fluid on the fluidic die 106b. In such examples, a fluidic actuator 110 in the form of a micro-pump may be disposed in a microfluidic channel. Accordingly, actuation of the fluidic actuator 110 in such examples may cause displacement of fluid in the microfluidic channel.

As used herein, a “fluid ejection device” and a “fluidic die” may denote part of a fluid ejection system 102 that dispenses fluid from one or more openings. A fluid ejection device includes a number of fluidic dies. “Fluid ejection device” and “fluidic die” are not limited to printing with ink and other printing fluids but may also include dispensing of other fluids and/or for uses other than printing.

In some examples, a thermal zone 108 may include at least one resistor segment 112b. A resistor segment 112b is a portion (e.g., section, length, part) of a resistor (e.g., thermal sense resistor (TSR)). For example, the resistor may span or travel through multiple thermal zones 108. The resistor segment 112b may be utilized to measure the temperature of the thermal zone 108. For example, it may be beneficial to know the temperature of the fluidic actuator(s) 110 (e.g., nozzles) in a given thermal zone 108. For example, the temperature may be utilized to adjust fluid actuation.

In some examples, the fluidic die 106b includes multiple thermal zones 108, where each thermal zone includes a resistor segment 112b coupled in series with another (e.g., a neighboring) resistor segment 112b of another (e.g., a neighboring) thermal zone 108. For example, a resistor (e.g., TSR) may include a series of resistor segments 112b that are coupled in series. In some examples, the fluidic die 106b may include a current source coupled to the resistor. For example, the resistor (e.g., a series of resistor segments 112b) may be coupled in series with a current source. For instance, a single current source may be utilized for all thermal zones 108 and/or resistor segments 112b.

In some examples, the fluidic die 106b includes switches coupled to each resistor segment 112b. For instance, each resistor segment 112b may be coupled to a pair of switches. One switch of the pair of switches may be coupled to a first side or end of the resistor segment, while the other switch of the pair of switches may be coupled to a second side or end of the resistor segment. In some examples, a switch or switches may be connected between (e.g., at a “midpoint” between) resistor segments. A switch is an electronic device for selectively connecting or disconnecting an electrical path. Examples of the switches include transistors and metal-oxide semiconductor field-effect transistors (MOSFETs).

In some examples, the fluidic die 106b includes a differential amplifier. The differential amplifier is an electronic device that amplifies a difference in voltage between inputs of the differential amplifier. The inputs of the differential amplifier may be coupled to the switches. For example, a pair of inputs of the differential amplifier may be coupled to each pair of switches. For instance, a first input of the differential amplifier may be coupled to a first switch of the pair of switches and a second input of the differential amplifier may be coupled to a second switch of the pair of switches (for each pair of switches).

The differential amplifier may output a temperature voltage signal for a thermal zone 108 or for thermal zones 108. For example, each pair of switches may be activated to produce a temperature voltage signal corresponding to each thermal zone 108. For instance, a pair of switches may be activated that correspond to one resistor segment 112b. A first switch may provide a voltage from a first side or end of the resistor segment 112b to a first input of the differential amplifier and a second switch may provide a voltage from a second side or end of the resistor segment 112b to a second input of the differential amplifier. The differential amplifier may measure the difference between the two voltages to provide the temperature voltage signal corresponding to that resistor segment 112b and/or thermal zone 108. This procedure may be repeated for each resistor segment 112b and/or thermal zone 108 to determine a temperature for each resistor segment 112b and/or thermal zone 108.

In some examples, switches may be activated to measure an average temperature over multiple resistor segments 112b and/or thermal zones 108. For example, one switch from two different pairs of switches may be activated and the differential amplifier may output an average temperature voltage signal corresponding to multiple thermal zones 108.

In some examples, the fluidic die 106b may include thermal control circuitry 116. The thermal control circuitry 116 may control thermal sensing for multiple thermal zones 108 and/or resistor segments 112b. For example, the thermal control circuitry 116 may selectively activate the switches to control temperature measurement for one thermal zone 108 (e.g., one resistor segment 112b), temperature measurement for a sequence of thermal zones 108 (e.g., a sequence of resistor segments 112b), and/or average temperature measurement over multiple thermal zones 108 (e.g., multiple resistor segments 112b). In some examples, the thermal control circuitry 116 may make a thermal control decision or decisions based on a temperature voltage signal.

In some examples, the differential amplifier may be included in the thermal control circuitry 116. For example, a single differential amplifier may be coupled to all of the resistor segments 112b. The thermal control circuitry 116 may control a gain of the differential amplifier. For example, the gain of the differential amplifier may be controlled based on a number of resistor segments 112b and/or thermal zones 108 being measured. For instance, in order to measure an average temperature of all thermal zones 108 (e.g., over all resistor segments 112b), the gain of the differential amplifier may be set to one. In order to measure a temperature of a single thermal zone 108 (e.g., one resistor segment 112b), the gain of the differential amplifier may be set to n, where n is a total number of resistor segments 112b and/or thermal zones 108.

FIG. 2 is a circuit diagram illustrating an example of fluidic die circuitry 218. The fluidic die circuitry 218 may be an example of, or may be included in an example of, the fluidic die 106b described in connection with FIG. 1B.

In some examples, the fluidic die circuitry 218 may include a plurality of resistor segments 212a-n connected in series. A resistor segment is a portion or length of a resistor. The resistor segments 212a-n may change resistance based on temperature. Accordingly, variations in voltage over a resistor segment may be utilized to determine a temperature at the resistor segment. In some examples, each thermal zone 208a-n may include a resistor segment 212a-n that is connected in series to another resistor segment 212a-n in another thermal zone 208a-n. A thermal zone is an area or region of a fluidic die.

In some examples, the fluidic die circuitry 218 includes a plurality of first switches 220a-n. As illustrated in FIG. 2, a first terminal of each of the first switches 220a-n may be connected to a first side of each of the plurality of resistor segments 212a-n. In some examples, the fluidic die circuitry 218 includes a plurality of second switches 222a-n. A first terminal of each of the second switches 222a-n may be connected to a second side of each of the plurality of resistor segments 212a-n. Examples of the first switches 220a-n and/or the second switches 222a-n may include field-effect transistors (FETs). For example, each of the first switches 220a-n may include first gates 221a-n and each of the second switches 222a-n may include second gates 223a-n. Each of the gates 221a-n, 223a-n may be individually addressable to enable selection of different combinations of resistor segments 212a-n.

In some examples, the fluidic die circuitry 218 may include a differential amplifier 224. The differential amplifier 224 may output a temperature voltage signal 226. In some examples, a first input of the differential amplifier 224 is connected to a second terminal of each of the first switches 220a-n. A second input of the differential amplifier 224 may be connected to a second terminal of each of the plurality of second switches 222a-n.

In some examples, each of the resistor segments 212a-n corresponds to a thermal zone 208a-n. The differential amplifier 224 may be a single differential amplifier 224 that may output a differential voltage (e.g., a temperature voltage signal 226) for each of the thermal zones 208a-n.

In some examples, the fluidic die circuitry 218 may include a current source 227 to drive the plurality of resistor segments 212a-n. For instance, the current source 227 may be a single current source to drive the plurality of resistor segments 212a-n.

In some examples, a first switch of the plurality of first switches 220a-n and a second switch of the plurality of second switches 222a-n may be activated to output the temperature voltage signal 226 for one of the resistor segments 212a-n. For example, first switch A 220a and second switch A 222a may be activated to output a temperature voltage signal 226 for resistor segment A 212a (e.g., thermal zone A 208a). Other respective pairs of the first switches 220b-n and the second switches 222b-n may be activated to output a temperature voltage signal 226 for other resistor segments 212b-n (e.g., for thermal zones B-N 208b-n).

In some examples, the differential amplifier 224 has a controllable gain that may be set based on a number of resistor segments measured in the plurality of resistor segments 212a-n. For example, the gain of the differential amplifier 224 may be set to n/m, where m is a number of resistor segments being measured and n is a total number of resistor segments. For instance, the differential amplifier 224 has a controllable gain that may be adjusted to a factor of one to output the average temperature voltage signal 226. More specifically, if an average temperature is being measured over all of the resistor segments 212a-n, the gain of the differential amplifier 224 may be set to one. In order to measure the average temperature for all thermal zones 208a-n and/or resistor segments 212a-n, first switch A 220a of the plurality of first switches 220a-n and second switch N 222n of the plurality of second switches 222a-n may be activated to output an average temperature voltage signal 226. In some examples, two switches (e.g., one first switch of the plurality of first switches 220a-n and one second switch of the plurality of second switches 222a-n) may be activated at a time. Controlling the gain of the differential amplifier 224 may be performed in order to output the same (or similar) range for various numbers of resistor segments 212a-n. For example, a greater gain may be set when measuring fewer segments.

If a temperature is being measured for a single resistor segment, the gain of the differential amplifier 224 may be set to n. In some examples, the controllable gain of the differential amplifier 224 may be set based on a number of resistor segments between a first switch that is activated of the plurality of first switches 220a-n and a second switch that is activated of the plurality of second switches 222a-n. For instance, if a set (e.g., contiguous set) of m resistor segments is being measured, the gain of the differential amplifier 224 may be set to n/m. For example, to measure an average temperature of thermal zones A-B 208a-b (e.g., two resistor segments A-B 212a-b), where first switch A 220a and second switch B 222b are activated and a total number of resistor segments 212a-n is 8, the gain of the differential amplifier 224 may be set to 8/2=4. In another example, to measure an average temperature of three thermal zones, the gain of the differential amplifier 224 may be set to 8/3. In another example, to measure an average temperature over all eight thermal zones, the gain of the differential amplifier 224 may be set to 8/8=1.

In some examples, the fluidic die circuitry may include a global current source 227 which forces a current into a resistor of n equal segments. There may be one resistor segment for each thermal zone, and all resistor segments 212a-n may be coupled in series. Two select switches at a common node between each resistor segment may allow the node voltage to be connected to the positive or negative terminal of the differential amplifier 224 with controllable gain.

Nodes of the biased segmented resistor may be selectively connected (via switches, for example) to the inputs of the differential amplifier 224. Connecting the heads of one of the n resistor segments to the differential amplifier 224 and setting the gain accordingly may generate a temperature voltage signal for a zone or zones. Connecting the nodes across the entire biased segmented resistor to the differential amplifier 224 and setting the gain to one may generate a global average temperature signal.

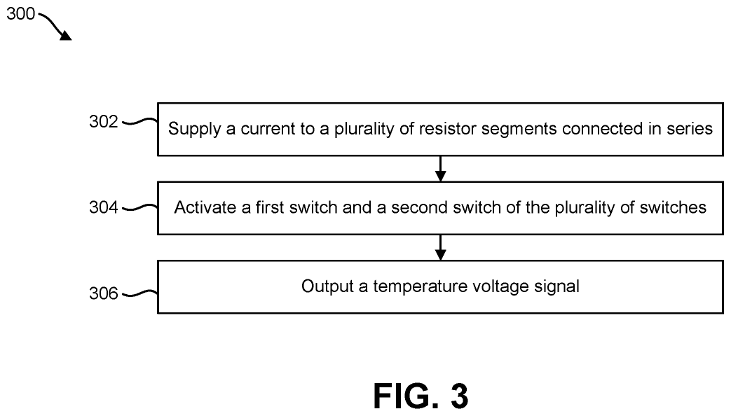

FIG. 3 is a flow diagram illustrating an example of a method 300 for temperature sensing. In some examples, the method 300 may be performed by the fluidic die 106b, the fluid ejection device 104, the fluid ejection system 102, and/or the fluidic die circuitry 218 described herein.

A fluidic die may supply 302 a current to a plurality of resistor segments connected in series. For example, a current source may supply the current to the series of resistor segments. As described herein, a pair of a plurality of switches may be coupled to each resistor segment of the plurality of resistor segments. In some examples, the resistor segments or the segmented resistor may be biased (by the fluidic die, for instance).

The fluidic die may activate 304 a first switch and a second switch of the plurality of switches. The first switch may be coupled to a first input of a differential amplifier and the second switch may be coupled to a second input of the differential amplifier. For example, activating the first switch may provide a first voltage to a first input of the differential amplifier via the first switch, and activating the second switch may provide a second voltage to a second input of the differential amplifier via the second switch. Accordingly, the fluidic die may connect selected nodes to the differential amplifier. In some examples, the fluidic die may set the gain of the differential amplifier. For instance, the fluidic die may set a gain of the differential amplifier based on a number of the plurality of resistor segments between the first switch and the second switch. For example, the gain may be set as a ratio between a total number of resistor segments to the number of resistor segments between the switches.

The fluidic die may output 306, from the differential amplifier, a temperature voltage signal. For example, the differential amplifier may measure a difference between the voltages provided by the switches to output the temperature voltage signal. The temperature voltage signal may indicate the temperature or average temperature corresponding to the resistor segment or resistor segments between the activated switches.

In an example, the first switch may be coupled to a first end of a first resistor segment of the plurality of resistor segments and the second switch may be coupled to a second end of the first resistor segment. In a case where the first switch and the second switch are activated, the temperature voltage signal may indicate a temperature of a thermal zone of the first resistor segment.

In some examples, the temperature voltage signal may be utilized to make a thermal control decision. For example, the fluidic die 106b, fluid ejection device 104, and/or fluid ejection system 102 may utilize the temperature voltage signal to make a thermal control decision. Some examples of thermal control decisions include activating or deactivating a heater of a zone. For instance, the temperature of a zone may be measured. If the temperature is lower than a defined threshold, then a heater in that zone may be activated to increase the temperature of that zone. If the temperature of the zone is higher than a defined threshold, then the heater for that zone may be deactivated if applicable.

In some examples, the thermal control circuitry 116, the fluid ejection device 104, and/or the fluid ejection system 102 described in connection with FIG. 1B may make a thermal control decision based on the temperature voltage signal. For example, the temperature voltage signal may be provided to an ADC in the thermal control circuitry 116, the fluid ejection device 104, or the fluid ejection system 102, which may convert the temperature voltage signal to a digital signal, which may indicate or be utilized to determine a temperature. The temperature may be compared to one or more thresholds to make the temperature control decision.

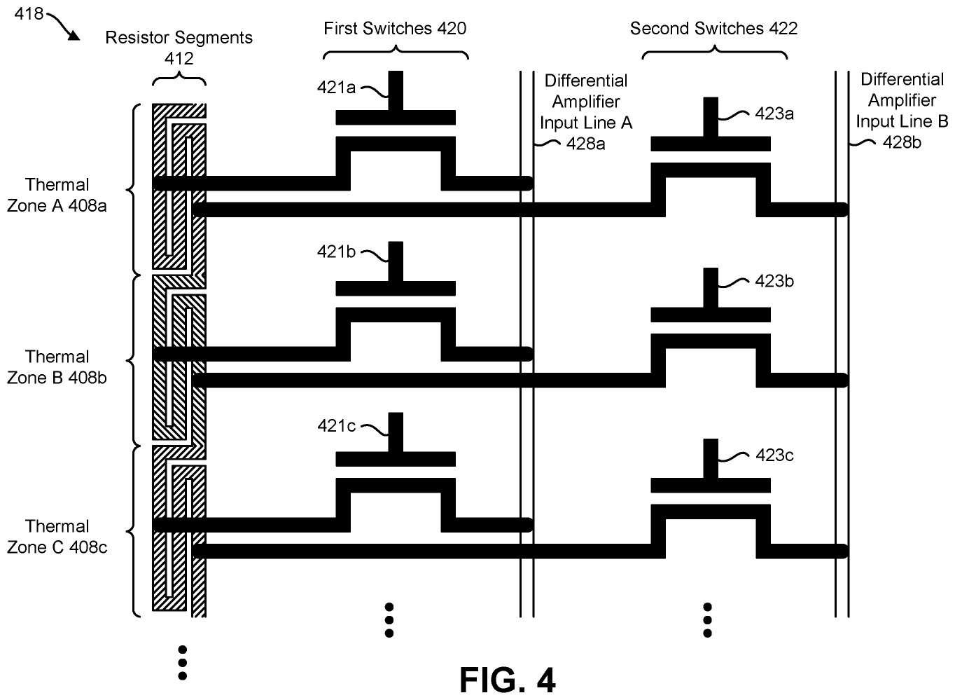

FIG. 4 is a diagram illustrating an example of fluidic die circuitry 418. Specifically, FIG. 4 illustrates resistor segments 412 of a resistor (e.g., TSR), thermal zones A-C 408a-c, first switches 420, and second switches 422. Selection signals may be applied to the first switches 420 and second switches 422 to select a thermal zone or multiple thermal zones. For example, the first switches 420 may include first gates 421a-c and the second switches 422 may include second gates 423a-c. The selection signals may be selective applied to the gates 421a-c, 423a-c to enable switching of individual or multiple resistor segments 412. The fluidic die circuitry 418 described in connection with FIG. 4 may be an example of the fluidic die circuitry 218 described in connection with FIG. 2.

As illustrated in FIG. 4, the first switches 420 are coupled to differential amplifier input line A 428a (e.g., an inverting input) and second switches 422 are coupled to input line B 428b (e.g., a non-inverting input). The first switches 420 may be coupled to an inverting input and the second switches 422 may be coupled to a non-inverting input or vice versa.

To achieve increased benefits of a differential sense topology, both differential nodes may be physically proximate (as much as possible, for example) from the point where they are connected to the resistor (e.g., TSR) to the point where they are coupled to the differential amplifier. This may help to ensure that both legs of the differential signal are exposed to equivalent electrical noise sources on the die. FIG. 4 illustrates one way that the resistor (e.g., TSR, resistor segments 412, etc.) can be implemented to achieve this. In this example, the resistor is (e.g., TSR is, the resistor segments 412 are) implemented in a single interconnect layer. Different hatching in FIG. 4 may identify unique thermal zones 408a-c.

It should be noted that in other examples, a different number of legs, etc., can be used. For any zone, it may be beneficial that the +/− pair (e.g., nodes) are physically proximate (as much as possible, for example) and that each leg is approximately identical.

It should be noted that in some examples, the selection logic may be implemented so that a zone includes multiple resistor segments (e.g., a + of one zone and a − of another zone), but this may be done at the possible expense of noise immunity.

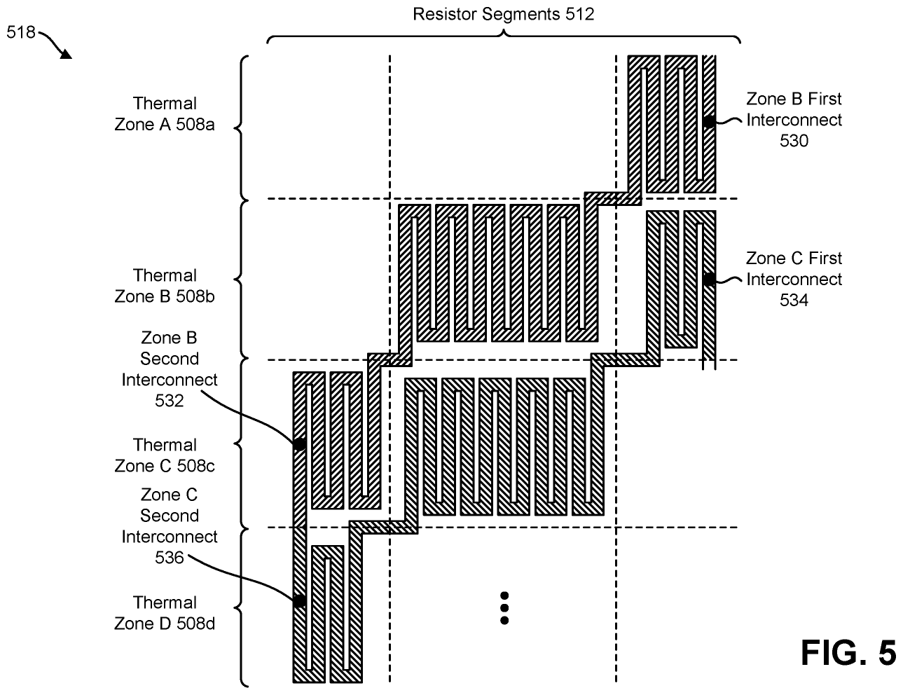

FIG. 5 is a diagram illustrating an example of fluidic die circuitry 518. Specifically, FIG. 5 illustrates resistor segments 512 of a resistor (e.g., TSR), thermal zones A-D 508a-d, and interconnects 530, 532, 534, 536 (i.e., interconnects to switches). The fluidic die circuitry 518 described in connection with FIG. 5 may be an example of the fluidic die circuitry 218 described in connection with FIG. 2.

In some examples, thermal zones may be implemented so that the resistor segment of a resistor (e.g., TSR) corresponding to a thermal zone is completely contained in a physical region associated with the zone. For example, each of the resistor segments 412 of FIG. 4 may be implemented completely within a physical region.

In some examples, a portion (e.g., X %) of a resistor segment may be contained in a physical region associated with a zone, and a complementary portion (e.g., 100%-X %) may be located outside of the physical region associated with the zone. The portion may vary based on implementation (e.g., 0.01% to 70%). For example, FIG. 5 illustrates an example where each of the resistor segments is partially contained within a zone. In this example, portions of the resistor that may correspond (partially or completely) to a resistor segment are illustrated with a hatching pattern. For example, a first resistor segment of the resistor segments 512 may run between the zone B first interconnect 530 and the zone B second interconnect 532. A second resistor segment of the resistor segments 512 may run between the zone C first interconnect 534 and the zone C second interconnect 536. As can be observed, a portion of the first resistor segment is in thermal zone B 508b, while other portions of the first resistor segment are located in thermal zone A 508a and thermal zone C 508c. Accordingly a portion of a resistor segment may be located in neighboring zones, as shown in FIG. 5.

In FIG. 5, the resistor segments 512 may be at the one layer of a fluidic die. As described above, different hatching illustrates different parts of the resistor that may correspond to different resistor segments and/or zones. The interconnects 530, 532, 534, 536 to switches may be implemented at a different layer from the resistor segments 512 and may be connected to the resistor segments 512. One benefit of the topology illustrated in FIG. 5 is that it may be implemented in two metal layers.

The structure illustrated in FIG. 5 may allow, depending on the value for a number of zones or of a current zone, an averaging function so that undesirable thermal discontinuities are not incorrectly sensed. In some examples, the design may be balanced for how much out-of-zone averaging contributes to a zone measurement by setting the out of zone resistor (e.g., TSR) length (with a number of bends, for example). It should be noted that FIG. 5 is not drawn to scale, and resistor geometries may be scaled to properly balance per-zone resistance and in- vs. out-of-zone resistance.

Some examples of the approaches for thermal sensing described herein may be beneficial. For instance some approaches for absolute thermal sensing (rather than relative or differential thermal sensing, for instance) may utilize a set of calibration parameters for each thermal sensor. Storing a large set of calibration parameters may increase complexity and cost. Some examples of the thermal sensing described herein may utilize a set of calibration parameters for each group of related thermal sensors (e.g., resistor segments), which may reduce the amount of calibration data stored.

In some examples, calibration requirements may be reduced due to one or more of the following: a single differential amplifier may be used in some examples to assess the differential voltage for all thermal zones associated with a single resistor (e.g., TSR), which may eliminate the need to calibrate for amplifier offset for each thermal zone. A single current source may be utilized to drive current onto the resistor (e.g., TSR) for measuring all thermal zones, which may eliminating the need to calibrate for current source variation for each thermal zone. For instance, variation in current mirrors may be a significant source of variation, which may lead to difficulties in calibration. A single current source and a single differential amplifier may be global to all zones (e.g., resistor segments), rather than using multiple amplifiers and/or current sources. In some examples, resistor (e.g., TSR) properties may be well matched for the resistor segment associated with each thermal zone, so calibration of each zone's sensor property may be reduced or eliminated.

Other potential advantages of the thermal sensing described herein are given as follows: some examples may offer compatibility with thermal control schemes. Some examples may be configurable for multiple zone sizes. Some examples may allow for both fine grained thermal measurements and larger-scale averages. Some examples may allow thermal sensing to operate independently of data loading and firing. Some examples may enable configurable levels of out of zone averaging for smooth responses to temperature gradients using a reduced number of interconnect levels.

1. A fluidic die for temperature sensing, comprising:
a plurality of resistor segments connected in series;
a plurality of first switches, wherein a first terminal of each of the first switches is connected to a first side of each of the plurality of resistor segments;
a plurality of second switches, wherein a first terminal of each of the second switches is connected to a second side of each of the plurality of resistor segments; and
a differential amplifier to output a temperature voltage signal, wherein a first input of the differential amplifier is connected to a second terminal of each of the first switches, and wherein a second input of the differential amplifier is connected to a second terminal of each of the plurality of second switches.

2. The fluidic die of claim 1, wherein each of the resistor segments corresponds to a thermal zone and the differential amplifier is a single differential amplifier to output a differential voltage for each of the thermal zones.

3. The fluidic die of claim 1, further comprising a single current source to drive the plurality of resistor segments.

4. The fluidic die of claim 1, wherein a first switch of the plurality of first switches and a second switch of the plurality of second switches are to be activated to output the temperature voltage signal for each of the resistor segments.

5. The fluidic die of claim 1, wherein a portion of each of the plurality of resistor segments is implemented in a neighboring thermal zone, and wherein the plurality of resistor segments is implemented in a first metal layer and interconnects to the plurality of resistor segments are implemented in a second metal layer.

6. The fluidic die of claim 1, wherein a controllable gain of the differential amplifier is to be set based on a number of resistor segments between a first switch that is activated of the plurality of first switches and a second switch that is activated of the plurality of second switches.

7. The fluidic die of claim 1, wherein a first switch of the plurality of first switches and a second switch of the plurality of second switches over all of the plurality of resistor segments are to be activated to output an average temperature voltage signal over all of the plurality of resistor segments.

8. The fluidic die of claim 1, further comprising a fluidic actuator and a fluid chamber for each of a plurality of thermal zones.

9. The fluidic die of claim 1, wherein the fluidic die is a fluid ejection die.

10. A fluidic die, comprising:
multiple thermal zones, wherein each thermal zone comprises a resistor segment coupled in series with a neighboring resistor segment of a neighboring thermal zone;
a pair of switches coupled to each resistor segment; and
a differential amplifier, wherein a pair of inputs of the differential amplifier are coupled to each pair of switches, and wherein the differential amplifier is to output a temperature voltage signal for each thermal zone.

11. The fluidic die of claim 10, wherein each pair of switches is to activate for each temperature voltage signal corresponding to each thermal zone.

12. The fluidic die of claim 10, wherein one switch from two different pairs of switches is to activate and the differential amplifier is to output an average temperature voltage signal corresponding to multiple thermal zones.

13. A method for temperature sensing by a fluidic die, comprising:
supplying a current to a plurality of resistor segments connected in series, wherein a pair of a plurality of switches is coupled to each resistor segment of the plurality of resistor segments;
activating a first switch and a second switch of the plurality of switches, wherein the first switch is coupled to a first input of a differential amplifier and the second switch is coupled to a second input of the differential amplifier; and
outputting, from the differential amplifier, a temperature voltage signal.

14. The method of claim 13, further comprising setting a gain of the differential amplifier based on a number of the plurality of resistor segments between the first switch and the second switch.

15. The method of claim 13, wherein the first switch is coupled to a first end of a first resistor segment of the plurality of resistor segments and the second switch is coupled to a second end of the first resistor segment, and wherein the temperature voltage signal indicates a temperature of a thermal zone of the first resistor segment.
